(19) United States
(12) Patent Application Publication
(10) Pub. No.: US 2007/0280444 A1
(43) Pub. Date: Dec. 6, 2007

(54) Method For Controlling Data Links

(76) Inventors: Hermann Granzer, Pocking (DE); Axel Scheuer, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/586,856

(22) PCT Filed: Aug. 27, 2004
(86) PCT No.: PCT/EP04/51942

§ 371 Date: May 21, 2007

(30) Foreign Application Priority Data
Jan. 20, 2004 (DE) 10 2004 002 915.6

(51) Int. Cl. H04M 7/00

(52) U.S. Cl. 379/93.14

(57) ABSTRACT

A method of gradually dismantling a data link between subscribers and by automatically setting up the data link between the subscribers with the aid of a trigger from one of the subscribers is provided.

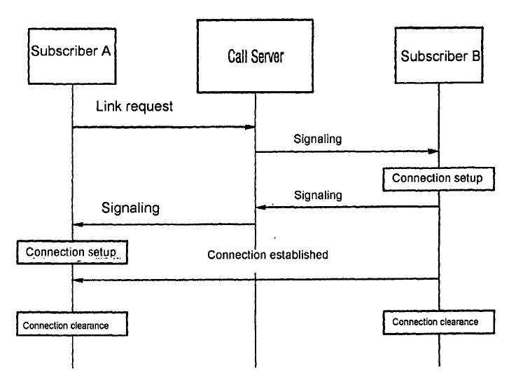

### CROSS REFERENCE TO RELATED APPLICATIONS

This application is the US National Stage of International Application No. PCT/EP2004/051942, filed Aug. 27, 2004 and claims the benefit thereof. The International Application claims the benefits of German application No. 102004002915.6 DE filed Jan. 20, 2004, both of the applications are incorporated by reference herein in their entirety.

### FIELD OF INVENTION

The present invention relates to a method for controlling data links.

### BACKGROUND OF INVENTION

The proliferation of services (videotelephony, video-on-demand, online gaming, messaging, etc.) must be supported by the provision of broadband data links in particular. This results in additional possibilities for using new services and features. For the user this has the advantage of his being able to always access new and more convenient communications services, and new, as yet unused added values result for the provider of these services. However, use of these services requires a data link which has a high bandwidth on the one hand (i.e. a high data transport volume) and which can be occupied over a relatively long period on the other.

However in practice this means significant expenditure for the user as the service provider (or the data link) has to provide the required resources permanently. The access units required for this purpose, or the physical terminals used in this case (what are known as “ports”) are expensive, however.

In the prior art there is only the possibility of constantly maintaining the data link. Thus it is only possible to establish an IP-based video link, for example, if both subscribing terminals are connected to the data network. Thus for example both PCs (Personal Computers) must be switched on, both video set-top boxes must maintain a constant data link, etc. As this is not normally the case, prior coordination of the two subscribers is required. The two must therefore make contact, typically via telephone, and coordinate themselves to activate their respective terminals and connect to the data network.

The permanent maintenance of a data link also impedes power-saving modes for example in the participating access units (power-down mode in DSLAM units in the case of a DSL access). The user therefore has much interest in avoiding unnecessary online times for energy-saving reasons alone. And last but not least these effects contributed to the rapid dying-out of the ISDN flatrate for internet access. With the proliferation of new value-added services, however, “availability on-demand” of the respective terminal is required.

### SUMMARY OF INVENTION

An object of the invention is to disclose a method as to how the use of services may be supported efficiently and inexpensively.

This object is achieved by the features in the independent claims.

A fundamental advantage of the invention can be seen in that the actual data link is initiated only if required (“on demand”). Need-controlled availability is thereby ensured. Expensive network resources are thus only occupied if they are actually required, whereby there is no associated restriction in the use of convenient value-added services. A possibility is therefore disclosed of how services which require the “always online” feature may be used.

This takes place in that the existing TDM technology is used more or less as a trigger for initiation of a data link. The TDM link always exists anyway, the corresponding terminals (ports) are basically always connected, so neither additional resources nor energy are consumed. Signaling may thus be transmitted via this existing TDM link to the receiving terminal, transferring a trigger to set up a data link to suitable terminals. This corresponds to “online on demand”, as is required for the above-described scenarios. In this case terminal-based and network-based triggering is possible.

A solution of this type results in optimum use of the resources or a saving in additional resources (resources are very effectively occupied and used only if required). The trigger for these data links can be transmitted via existing land-line network structures, for example as a land-line SMS. An expansion and a different type of signaling with more extensive contents and possibilities are also conceivable (for example with the aid of the ISDN D-channel, DTMF signaling or via control voltage signals).

Advantageous developments of the invention are recited in the dependent claims.

### BRIEF DESCRIPTION OF THE DRAWING

The invention will be described in more detail hereinafter with reference to a FIGURE . The sole FIGURE illustrates an exemplary embodiment of controlling a data link between two subscribers in accordance with the present invention.

### DETAILED DESCRIPTION OF INVENTION

Accordingly it is provided that a subscriber wishes to transmit to another subscriber a multimedia message (for example a song, a picture, a short video as a greeting) (multimedia messaging). As his receiving device is not connected to the data link (“offline”), this intention would not succeed, i.e. no contact is established. The service provider and the provider of the communications network thus lose potential earnings or profit.

According to the invention it is proposed that a TDM-based trigger precede the actual data transmission. The receiving subscriber terminal receives this trigger (before the (normal) telephone receives it for example, as in the case of an SMS), sets up a data link, signals its ready-to-receive state and can subsequently receive the corresponding message. Once this automatically executed communication has ended the data link may be set up again, possibly after a certain delay or renewed trigger. The term “data link” should be very broadly defined in this case. Thus speech links should also be regarded as data links. Links which provide an ISDN D-channel, DTMF signaling or control voltage signals should also be included here.

In a first configuration of the invention the trigger is constructed as a network-based trigger. This means that a central device in the network controls these operations. The FIGURE shows the corresponding relationships. If therefore subscriber A sends a link request to subscriber B, a central network device identifies the corresponding signaling information, interprets it and evaluates it. The central device stores the state of the terminals A, B. If the terminal of subscriber A cannot accept this link as the terminal is inactive, the network or corresponding network entities (for example call servers) initiate(s) trigger signaling to subscriber B. This may also take place without knowledge of the state of B, more or less “by way of a precaution”, in order to avoid the B state being stored and thus prevent faults. The B terminal subsequently sets up the data link and signals its ready state to the network or the corresponding network entity. This may accordingly fully establish communication between A and B. The advantage of this solution lies in the central logic which deals with control and the fee payment option for services of this type.

In a further configuration of the invention it is provided that the trigger is constructed as an end subscriber-based trigger. If therefore subscriber A wants to communicate with subscriber B via a data link (for example a video call), the terminal associated with subscriber A transmits signaling to the terminal of subscriber B. This terminal receives the signaling and sets up the data link. Subscriber terminal B informs subscriber terminal A (optionally via the now created data link) of the fact that the link exists and A can accordingly set up the link as desired. Alternatively, the terminal of subscriber A can also simply repeatedly “test” whether the message can now be delivered. First-time signaling of the ready-to-receive state of B is not imperative therefore.

In a specific solution to this end subscriber-based trigger a land-line network SMS is provided as a trigger. This means that the trigger is transmitted from A to B on the land-line network via SMS. Subscriber A wishes, for example, to send subscriber B a multimedia message. He uses his terminal, compiles the message and initiates dispatch. In a manner that is completely transparent for him, his terminal first transmits an SMS message, which contains a specific trigger content, to subscriber B (for example “Action=get_ready_for_reception; Code=MultiMediaMessage; Sender=A”). The terminal of subscriber B can receive this SMS and interprets the content. If it is understood and accepted the B-side terminal establishes a data link and optionally signals to the terminal of subscriber A its ready-to-receive state via a further SMS (Action=send_now; Code=MultiMediaMessage; Receiver=B). The terminal of subscriber A can now also establish the data link and send the actual message. Following transfer the two terminals disconnect the data link again. A video link may also be set up in exactly the same way. Even MMS on the land-line network is entirely independently conceivable.

This procedure ensures that expensive data links are only set up both at side A and side B if the two sides are ready to exchange messages. The same method may of course also be analogously used to set up speech or video links. In principle this procedure may be extended to the entire network. Thus subscriber A can trigger subscriber B who thereupon transfers a message to subscriber C.

The particular advantage of the invention can be seen in the fact that the data link does not necessarily have to be broad-band. The invention can also deal with narrow-band data links. Potential commercial uses for the triggers might for example be streaming of TV contents to end customer equipment, such as TV sets, video recorders and set-top boxes. Network-internal streaming to distribution stations (multicast points) is also conceivable, as is direct delivery of e-mails without PC action or action of the e-mail software thereof being necessary. Finally, the invention may also be used in the home network. (Sending warning information or monitoring information (“break-in”, “water damage”, “heating failed”) to service providers or corresponding customer terminals (cell phones)).

1.-6. (canceled)

7. A method for automatically setting up a data link between a first subscriber and a second subscriber, comprising:
forming a TDM based trigger;
transmitting the trigger from the first subscriber over a land-line network to the second subscriber;
receiving the trigger by the second subscriber; and
establishing the data link between the first and second subscribers by the second subscriber in response to receiving the trigger.

8. The method as claimed in claim 7, wherein the trigger is formed in accordance to SMS.

9. The method as claimed in claim 8, further comprising informing the first subscriber of the existence of the data link by the second subscriber.

10. The method as claimed in claim 9, wherein the first subscriber is informed via the data link.

11. The method as claimed in claim 8, wherein the data link is broad-band.

12. The method as claimed in claim 8, wherein the data link is narrow-band.

13. A method for automatically setting up a data link between a first subscriber and a second subscriber, comprising:
forming a first TDM based trigger in a accordance to SMS;
transmitting the first TDM trigger from the first subscriber over a land-line network to a central device;
receiving the first trigger by the central device;
initiating a second trigger to the second subscriber from the central device in response to receiving the first trigger;
receiving the second trigger by the second subscriber; and
establishing the data link between the first and second subscribers by the second subscriber in response to receiving the second trigger.

14. The method as claimed in claim 13, wherein the data link is broad-band.

15. The method as claimed in claim 13, wherein the data link is narrow-band.

16. A method for controlling a data link between at least two subscribers, comprising:
providing a first and second subscriber;
forming a TDM based trigger; and
sending the TDM-based trigger by the first subscriber whereby the data link is automatically set up between the first and second subscriber.

17. The method as claimed in claim 16, wherein the trigger is end subscriber-based.

18. The method as claimed in claim 16, wherein the trigger is constructed as an SMS land-line network message.

19. The method as claimed in claim 16, wherein the trigger is network-based

20. The method as claimed in claim 16, wherein the data link is broad-band.

21. The method as claimed in claim 16, wherein the data link is narrow-band.
